(19) United States
(12) Patent Application Publication
(10) Pub. No.: US 2021/0002541 A1
(43) Pub. Date: Jan. 7, 2021

(54) TREATMENT OF OIL AND GAS WELLS AND OIL HANDLING EQUIPMENT

(71) Applicants: Arthur L. ALSUP, Bloomfield, NM (US); Lake Country Fracwater Specialists, LLC, Pace, FL (US); ELD Resources, LLC, Pace, FL (US)

(72) Inventors: Timothy PHILLIPS, Bloomfield, NM (US); Lea PHILLIPS, Bloomfield, NM (US); Francis MILLER, Pace, FL (US); Arthur L. ALSUP, Bloomfield, NM (US)

(73) Assignees: Lake Country Fracwater Specialists, LLC, Pace, FL (US); ELD Resources, LLC, Pace, FL (US); Arthur L. ALSUP, Pace, FL (US)

(21) Appl. No.: 16/977,429

(22) PCT Filed: Mar. 1, 2019
(86) PCT No.: PCT/US2019/020195

§ 371 Date: Sep. 1, 2020

Related U.S. Application Data
(60) Provisional application No. 62/637,834, filed on Mar. 2, 2018.

(51) Int. Cl. C09K 8/524; E21B 37/06

(52) U.S. Cl. CPC C09K 8/524; E21B 37/06

(57) ABSTRACT

A method of treating an oil well or a gas well to restore production capacity. In certain embodiments, the method comprises mixing a coagulant, a surfactant, and water or production brine to produce a well treatment mixture; injecting the treatment mixture into the oil well; operating the oil well to distribute the treatment mixture throughout the oil well; and withdrawing a the treatment mixture, oil, production brine, and oil waste constituents from the oil well. As a result of the treatment compositions and methods, the oil waste constituents may include dissolved and or delaminated paraffin removed from surfaces of the oil well. In certain embodiments, following treatment, the oil well is substantially free of paraffin deposits.

### TECHNICAL FIELD

Oil well drilling and production of hydrocarbon oils from drilled wells.

### BACKGROUND ART

In oil production from a well, a problem occurs within the well structure. During the production of oil, several methods may be utilized in lifting the oil, water and gas to ground level simultaneously. Some examples are using a pump jack, gas lift, or downhole pump to lift the oil. In many cases, the oil well will produce paraffin as a component of the oil. Crude oils are known to contain dissolved paraffin waxes that can precipitate and deposit under the certain environmental conditions. Paraffin wax produced from crude oil is comprised of long chain, saturated hydrocarbons (linear alkanes/n-paraffins) with carbon chain lengths of C18 to C75+, and having melting points from 40 to 70° C. This wax material is referred to as “microcrystalline wax.” Naphthenic hydrocarbons (C18 to C36) also deposit wax, which is referred to as “microcrystalline wax.” Macrocrystalline waxes lead to paraffin problems in production and transport operations; microcrystalline waxes also contribute the most to storage and production tank-bottom sludges.

Wax deposition onto the production system (“growth”) generally requires a “nucleating agent,” such as asphaltenes and inorganic solids, which are commonly present in the produced oil. The wax deposits vary in consistency from a soft mush to a hard, brittle material. Paraffin deposits will be harder, if longer-chain n-paraffins are present.

In summary, there is a problem in producing oil from a well, in which solid paraffin deposits build up in structures within the oil well and pipelines connected to it. These deposits restrict upward oil flow, resulting in lower oil volume produced from the well, and at a lower production flow rate. In addition these deposits in downstream equipment produce flow problems and impact oil quality and treatment requirements. These deposits are also found in natural gas wells resulting in similar reductions in flow rates.

According to current practice, the problem of paraffin deposits in an oil well is dealt with by hot oil treatments or mechanical “cutting” of the paraffins from the well bore. This practice is disadvantageous primarily due to the cost and disruptive nature of the process at the well site. In addition the hot oil treatments also include potential health, safety, and environmental hazards.

Hence the problem of paraffin deposits in an oil well remains without a simple, lower cost and more environmentally friendly solution. What is needed to address this problem is a method and apparatus for treating an oil well so as to remove accumulated paraffin deposits, thereby restoring the production oil flow capacity of the well.

### SUMMARY

To solve the problem of restrictive buildup of paraffin waxes within an oil well, and restore the oil well to a high production capacity, the Applicants have discovered a process which is capable of removing the waxes from the oil well. The Applicants' process includes directly injecting a mixture including an amphoteric surfactant and a coagulant chemical down the annulus (backside) of the oil well. During this process the mixture may be slowly added to the annulus and optionally, to the production casing in the case of natural gas wells. As the mixture makes contact with the downhole fluids, it is gradually blended with crude oil in the bottom of the well.

Without wishing to be bound to any particular theory, the Applicants believe that as the oil is lifted from the well, increased shear is achieved by the migration of the fluids to surface, gas pressure, and by the mechanical forces of the lifting equipment; and that this effect in combination with the treatment compositions/mixtures subsequently removes the paraffin scaling from the pipe and other surfaces by maintaining the paraffin in a liquid state in all downhole lifting equipment (and without damaging sub-surface equipment), and additionally in surface fluid separations systems such as two and three phase separators and holding tanks. The treatment mixture appears to also remove the asphaltenes, which are also problematic to the quality of the oil, through this same mechanism. The Applicants' well treatment method and compositions also promote better separation in the separation vessels as the treatment composition makes its way through the oil production process. The treatment has been shown to have no deleterious impact on the oil quality. In fact the treatment process has been shown to improve the quality of the oil within the production tanks.

More specifically, in accordance with the present disclosure, there is provided a method of treating an oil well. The oil well is comprised of casing disposed in the earth and includes a distal end penetrating a geologic formation containing oil and/or natural gas, typically. The method comprises mixing a coagulant, a surfactant, and water to produce a well treatment mixture; injecting the treatment mixture into the oil well; operating the oil well to distribute the treatment mixture throughout the upper portion of the oil well; and withdrawing oil and production brine from the oil well with the treatment mixture and waste constituents including dissolved/delaminated paraffin dispersed in the oil.

The oil well may be obstructed with paraffin deposits. As a result of the treatment compositions and methods, the oil may include paraffin removed from surfaces of the oil well. In certain embodiments, following each treatment, the oil well is substantially free of paraffin deposits. The method may further comprise preventing freezing of an aqueous portion of the treatment mixture by adding at least one of chloride salts or nitrate to lower the freezing temperature of the mixture.

In accordance with the present disclosure, there is further provided a method of treating a gas well. The method comprises mixing a coagulant, a surfactant, and water to produce a well treatment mixture; injecting the treatment mixture into the gas well; operating the gas well to distribute the treatment mixture throughout the upper portion of the gas well; and withdrawing natural gas and production brine from the gas well containing a mixture of natural gas, production brine, the treatment mixture and other constituents including dissolved and/or delaminated paraffins. In certain embodiments, following each treatment, the gas well is substantially free of paraffin deposits. The method may further comprise preventing freezing of an aqueous portion of the treatment mixture by adding at least one of chloride salts or nitrate to lower the freezing temperature of the mixture.

In accordance with the present disclosure, there is further provided a method of treating oil handling and/or storage equipment. The method comprises mixing a coagulant, a surfactant, and water or production brine to produce an equipment treatment mixture; injecting the treatment mixture into the equipment; operating the equipment to distribute the treatment mixture throughout the equipment; and withdrawing a mixture from the equipment, the withdrawn mixture comprised of oil, treatment mixture and constituents including dissolved or delaminated paraffins.

The equipment may have undesired paraffin deposits. As a result of the treatment compositions and methods, the withdrawn mixture may include paraffin removed from surfaces of the equipment. In certain embodiments, following each treatment, the equipment is substantially free of paraffin deposits. The method may further comprise preventing freezing of an aqueous portion of the treatment mixture by adding at least one of chloride salts or nitrate to lower the freezing temperature of the mixture.

In accordance with the present disclosure, there is further provided a liquid composition comprised of a mixture of an amphoteric surfactant, an aluminum chloride form of a coagulant; and water or brine; or the mixture of an amphoteric surfactant and an aluminum chloride form of a coagulant. The mixture may be used in treatment of oil and gas wells, and production and storage equipment used in the operation thereof.

### BRIEF DESCRIPTION OF THE DRAWINGS

The present disclosure will be provided with reference to the following drawings, in which like numerals refer to like elements, and in which:

FIG. 1 is a schematic diagram of an oil well that can be treated with the material compositions and methods of the present disclosure; and

FIG. 2 is a flowchart depicting a method of treating an oil well in accordance with the invention.

The present invention will be described in connection with certain preferred embodiments. However, it is to be understood that there is no intent to limit the invention to the embodiments described. On the contrary, the intent is to cover all alternatives, modifications, and equivalents as may be included within the spirit and scope of the invention as defined by the appended claims.

### BEST MODE FOR CARRYING OUT THE INVENTION

For a general understanding of the present invention, reference is made to the drawings. In the drawings, like reference numerals have been used throughout to designate identical elements.

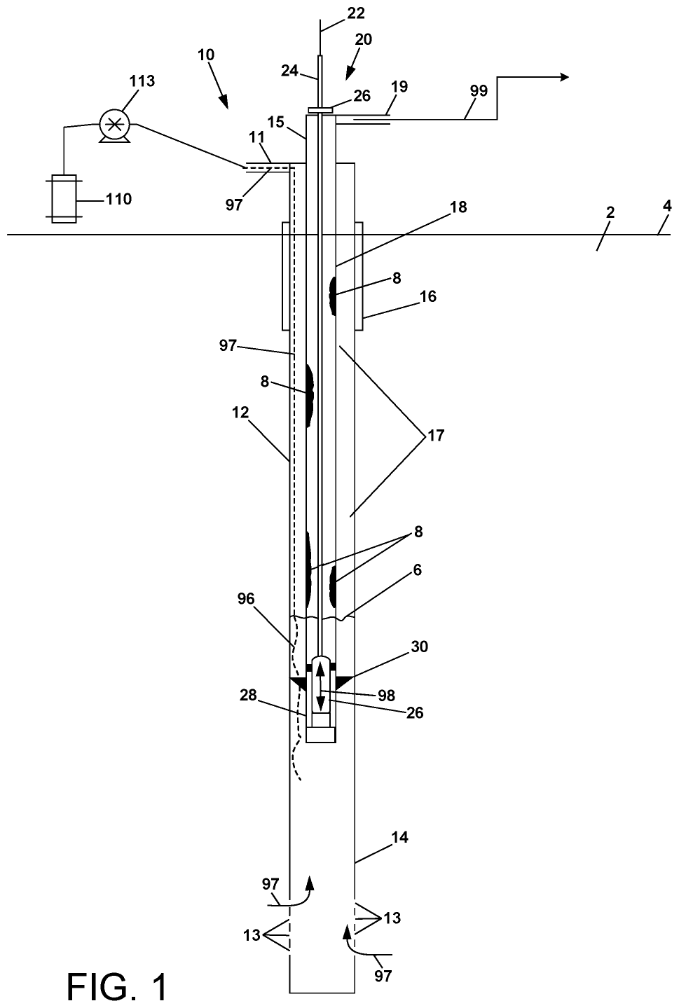

The Applicants' oil well treatment methods and compositions are now described. Referring first to FIG. 1, an exemplary oil well 10 is depicted, which is treatable with the methods and compositions of the present disclosure. It is to be understood that the structure of the oil well may vary from that shown in FIG. 1, with the Applicants' treatment process and treatment chemicals being effective in treating such oil wells. The oil well 10 of FIG. 1 is comprised of a casing 12 disposed in the earth 2 and includes a distal end 14 penetrating a geologic formation (not shown) containing oil, gas, and water. A surface casing 16 of a suitable material such as concrete surrounds the casing 12 to provide sealing and stability at the ground surface 4. The oil well is further comprised of an outlet pipe 18 (also referred to in the art as the “Production String” or “Tubing”) contained within the casing 12, and extending proximate to the distal end 14 of the casing 12 (also referred to as “Total Depth,”; or “True Vertical Depth,” TVD) or at and near the fluid level within the well.

The oil well 10 is further comprised of a reciprocating pump assembly 20, which withdraws the oil and production brine upwardly from an oil level 6 through the outlet pipe 18, and out through an exit pipe 19 in the wellhead 15, as indicated by arrow 99. Natural gas may also be present in the upper annular region 17 between the casing 12 and the outlet pipe 18. The pump assembly 20 is comprised of a pump jack (not shown), which reciprocates upwardly and downwardly. The pump jack is operatively connected to a bridle 22, which in turn is connected to a rod 24 that extends downwardly through a seal 26. In certain embodiments, the seal 26 may be a stuffing box type seal, and the rod 24 may be polished so as to enable smooth reciprocating motion and minimal seal wear. The rod 24 is connected to a plunger and ball assembly 26, which is contained within a pump barrel 28, which is held in a fixed position within the casing 12 by a tubing anchor 30. In operation of the well 10, the pump jack oscillates the plunger and ball assembly 26 upwardly and downwardly as indicated by arrow 98. The plunger and ball assembly 26 includes a check valve device (not shown), which permits oil flow in the upward direction through the plunger and ball assembly 26 when the plunger and ball assembly 26 is moving downward, but prevents oil flow in the downward direction through the plunger and ball assembly 26 when the plunger and ball assembly 26 is moving upward. In that manner, the reciprocating motion of the plunger and ball assembly 26 causes lateral flow of oil from the geologic formation through perforations 13 in the casing as indicated by arrows 97 and upward flow of the oil through the outlet pipe 18 and the exit pipe 19 as indicated by arrow 99.

As described previously, a problem occurs in the operation of the oil well in that paraffin deposits 8 form on the inner wall of the outlet pipe 18, and/or on the reciprocating rod 24. Such deposits restrict the flow of oil out of the well, and may also interfere with the reciprocating motion of the plunger and ball assembly 26. At some point when the deposits become severe enough, the oil well 10 must be shut down for removal of the paraffin deposits. Any interruption or restriction of production of oil from the well is very costly.

The Applicants have discovered that certain compositions comprised of combinations of materials are surprisingly effective in breaking down highly viscous and/or viscoelastic oils, sludge, and paraffin that may be restricting the production capacity of an oil well. In one aspect of a method of treating an oil well, the materials may be utilized as a “backside” injection fluid for wells that produce oil and paraffin. The materials may be delivered into the annular space between the outlet pipe and the wellbore casing, as well as any and all downhole volume in the well beyond the casing and may also be utilized down the production string, outlet pipe and/or through the various lift system or any other subsurface mechanical or non-mechanical equipment connected to the well.

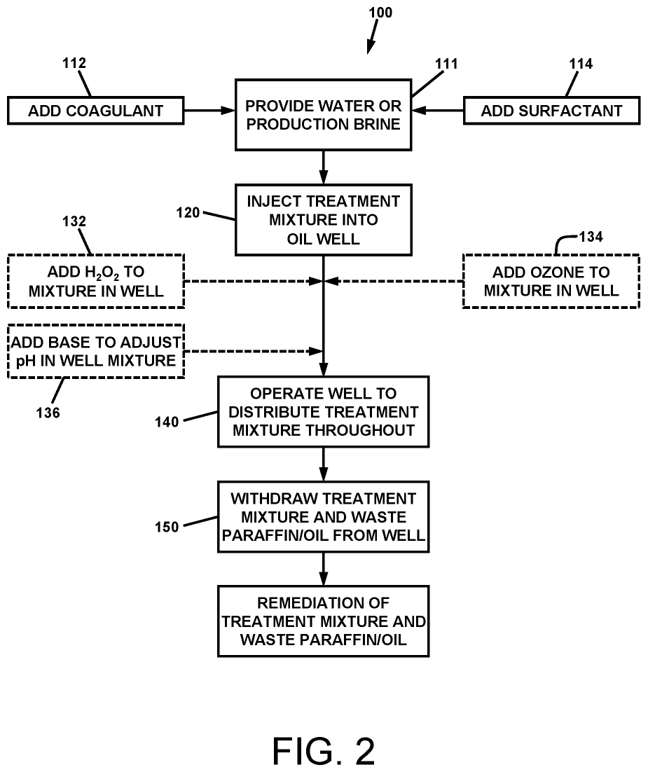

More specifically, referring to FIG. 2, the method 100 comprises step 111 of preparing a well treatment mixture. To begin, a vessel 110 (FIG. 1) containing water or production brine is provided. A coagulant is added in step 112 to the water or production brine. The coagulant is preferably an aluminum chlorhydrate, and is added at concentration of approximately 0.1% to 1% by volume based on the total volume of liquid.

A surfactant is added in step 114 to the mixture. The surfactant is preferably an amphoteric surfactant. In one embodiment, the surfactant may be made by combining chloroacetic acid with the amide derived from dimethylaminopropylamine and lauric acid. In certain embodiments, the surfactant may be {[3-(Dodecanoylamino) propyl](dimethyl)ammonio} acetate. Such surfactant is added to the mixture at concentration of approximately 15% to 50% by volume based on the total volume of liquid.

With the preparation of the oil well treatment composition/mixture completed, the mixture is then injected into the oil well in step 120. Referring also to FIG. 1, the liquid mixture may be delivered from a tank, drum, pail or similar vessel 110 by pump 113 into an inlet pipe 11 into the top of casing 12. The treatment mixture flows downwardly through the annular space between the inner wall of the casing 12 and the outer wall of the outlet pipe 18, as indicated schematically by dotted line 97. The liquid mixture reaches the oil level 6 within the casing 12, and mixes into the oil as indicated by dotted line 96. This process may be performed on a continuous basis or on an intermittent basis dependent upon the particular application requirements.

In step 140, the oil well is operated such that reciprocating motion of the plunger and ball assembly 26 causes mixing of the mixture into the oil and distribution of the treatment mixture throughout the upper portion of the well. The treatment mixture contacts any paraffin deposits (not shown) on the inner wall of the casing and/or obstructing the perforations 13 in the casing 18 near the upper portion of the well, and causes such deposits to dissolve and/or delaminate from the inner wall. Additionally, the reciprocating action of the plunger and ball assembly 26 causes the treatment mixture to be delivered upwardly within the outlet pipe 18 and mixed into the oil within the outlet pipe 18. The treatment mixture contacts any paraffin deposits 8 on the inner wall of the outlet pipe 18, on the rod 24 and within the plunger and ball assembly 26. The shearing effect of fluid flow and the chemical constituents present in the treatment mixture causes such deposits to dissolve and/or delaminate from the inner wall.

Thus a mixture of oil, treatment mixture, and delaminated paraffin is formed in the annulus within the casing 12 and outlet pipe of the well 10. In step 150, continued operation of the well 10 and/or the pump 110 delivering treatment mixture into the well causes the flow of oil, treatment mixture, and delaminated paraffin out of the well as indicated by arrow 99 and to a production tank or similar vessel.

Alternative treatment mixtures are contemplated. The Applicants have further discovered that depending upon the nature of the contaminants present within the well, successful treatment may be achieved with the amphoteric surfactant alone, the amphoteric surfactant mixed with water or production brine, the amphoteric surfactant mixed with coagulant, or the amphoteric surfactant mixed with water or brine plus the coagulant. Additionally, further constituents may be injected into the oil well after the initial delivery of the treatment mixture. However optimum treatment was achieved with a unique mixture of the coagulant plus the surfactant plus water in ratios of approximately 15% to 50% surfactant, 50% to 85% water or production brine and trace amounts of coagulant typically between 0.1% and 1% by volume.

Advantageously, as a result of the use of the Applicants' treatments and compositions, an oil well is rendered substantially free of paraffin deposits. As used herein, “substantially free” means that the paraffin deposits are removed to a degree that the oil well is restored to near its original production capacity.

Moreover, the Applicants' well treatment mixture and related method may be utilized to clean outlet pipe perforations, thin the contaminated oil in the well bore volume and well production pipe for easier lifting, and clean downhole tools and related piping. As this well treatment mixture flows from the well through the production string to additional surface equipment, e.g. separators and holding tanks, it cleans this equipment as well. This results in more efficient water/oil separation inside a storage and or separation vessel, and promotes better separation of oil, sludge, and water in the holding tanks.

In addition, the Applicants believe that the presence of the particular surfactant blended into the oil treatment chemical has the additional effect of coagulating some of the inorganic matter in the well, which mitigates some of the precipitation of scale on the well and pumping system surfaces and also at the perforations in the regions of the well where the treatment is present.

Under ambient conditions which may lead to freezing of the aqueous portion of the treatment mixture, salt water such as clean produced water from an oil or gas well or a salt water solution of salts such as sodium chloride of calcium chloride or magnesium chloride or calcium nitrate may be utilized as a substitute for the fresh water in the mixture. Appropriate concentrations of these chloride salts may be used based upon the anticipated temperatures and published concentrations required to suppress the freezing point of the aqueous portion to below the anticipated temperatures.

It is further noted that the use of the Applicants' treatment compositions and methods are not limited only to treatment of oil wells. The process has been successfully applied to natural gas production wells wherein alternate injection methods are utilized based upon the different mechanical configuration of a natural gas well. The compositions and methods may be used to treat other oil handling and oil processing equipment including but not limited to production tanks, gathering pipeline systems, central distribution pipelines, and midstream oil facilities and/or refineries. In particular, the Applicants' oil well treatment compositions and methods may also be use in petroleum refineries to produce the same results in pipeline infrastructure, further oil separation, and internal equipment cleaning, whilst promoting increased production and decreased cost to the refinery operator.

It is, therefore, apparent that there has been provided, in accordance with the present invention, a method and apparatus for treatment of contaminated oil at an oil well or in production tanks or a central receiving or treatment location. Having thus described the basic concept of the invention, it will be rather apparent to those skilled in the art that the foregoing detailed disclosure is intended to be presented by way of example only, and is not limiting. Various alterations, improvements, and modifications will occur to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in subsequent claims.

We claim:

1. A method of treating an oil well, the method comprising:
a) mixing a coagulant, a surfactant, and water or production brine or other salt water to produce a well treatment mixture;
b) injecting the treatment mixture into the oil well;
c) operating the oil well to distribute the treatment mixture throughout the upper portion of the oil well; and
d) withdrawing oil and production brine from the oil well containing a mixture of oil, the treatment mixture and other constituents including dissolved and/or delaminated paraffins.

2. The method of claim 1, wherein following treatment, the oil well is substantially free of paraffin deposits.

3. The method of claim 1, further comprising preventing freezing of an aqueous portion of the treatment mixture by adding at least one of chloride salts or nitrate to lower the freezing temperature of the mixture.

4. A method of treating natural gas well, the method comprising:
a) mixing a coagulant, a surfactant, and water or production brine to produce a well treatment mixture;
b) injecting the treatment mixture into the gas well;
c) operating the gas well to distribute the treatment mixture throughout the upper portion of the gas well; and
d) withdrawing natural gas and production brine from the gas well containing a mixture of natural gas, production brine, the treatment mixture and other constituents including dissolved and/or delaminated paraffins.

5. The method of claim 4, wherein following treatment, the gas well is substantially free of paraffin deposits.

6. The method of claim 4, further comprising preventing freezing of an aqueous portion of the treatment mixture by adding at least one of chloride salts or nitrate to lower the freezing temperature of the mixture.

7. A method of treating oil handling and/or storage equipment, the method comprising:
a) mixing a coagulant, a surfactant, and water or production brine to produce an equipment treatment mixture;
b) injecting the treatment mixture into the equipment;
c) operating the equipment to distribute the treatment mixture throughout the equipment; and
d) withdrawing a mixture from the equipment, the withdrawn mixture comprised of oil, treatment mixture and constituents including dissolved or delaminated paraffins.

8. The method of claim 7, wherein following treatment, the equipment is substantially free of paraffin deposits and wherein oil contained in treated vessels has improved quality.

9. The method of claim 7, further comprising preventing freezing of an aqueous portion of the treatment mixture by adding at least one of chloride salts or nitrate to lower the freezing temperature of the mixture.

10. A liquid composition comprised of a mixture of an amphoteric surfactant, an aluminum chloride form of a coagulant and brine.
